(19) United States
(12) Patent Application Publication
(10) Pub. No.: US 2009/0223782 A1
(43) Pub. Date: Sep. 10, 2009

(54) PACKAGING MACHINE WITH ADJUSTABLE LANES

(76) Inventors: Alan P Martin, Smyrna, GA (US); John W. Cash, III, Dallas, GA (US); Jeffrey G. Jacob, Buford, GA (US); Rafe T. Patterson, Newnan, GA (US); John G. Hotchkiss, Duluth, GA (US); Pattrick B. King, Smyrna, GA (US); Robert G. Rosenzweig, Atlanta, GA (US)

Correspondence Address: MEADWESTVACO CORPORATION;ATTN: IP LEGAL DEPARTMENT, 1021 MAIN CAMPUS DRIVE, RALEIGH, NC, 27606, US

(21) Appl. No.: 12/097,619

(22) PCT Filed: Dec. 18, 2006
(86) PCT No.: PCT/US2006/062251

§ 371 Date: Oct. 8, 2008

Related U.S. Application Data
(60) Provisional application No. 60/751,136, filed on Dec. 16, 2005.

(51) Int. Cl. B65G 21/20; B65G 47/00; G06F 7/00

(52) U.S. Cl. 198/617; 198/836.3; 700/230

(57) ABSTRACT

A packaging apparatus (10) includes lanes (L) in which articles (C) are conveyed and grouped. Each lane (L) is defined by lane dividers (16a, 16b, 18, 20) and includes an upstream portion (12) and a downstream portion (14). The upstream portion (16) is defined by lane dividers (16a, 16b) that are substantially parallel to a first axis (X). The downstream portion (14) is defined by lane dividers (18, 20) that are substantially parallel to a second axis (Y), which is at an angle (A) with respect to the first axis (X). The width (W2) of the downstream portion (14) of each lane (L) is adjustable as an adjustable one of the lane dividers (20) that define the downstream portion (14) translates parallel to the first axis (X).

### TECHNICAL FIELD

This invention relates generally to packaging machines and, more specifically, to a packaging machine with adjustable lanes.

### DESCRIPTION OF THE RELATED ART

Various types of packaging machines are designed to package articles, such as bottles or cans, into a unitary container such as a paperboard carton. These packaging machines group a number of articles in a certain manner to correspond with the approximate container dimensions, and the article group is then transferred into the container. The container is then sealed or otherwise closed to contain the article group.

Known packaging machines utilize guide rails or lane dividers to define lanes which direct the articles along flow paths. Selector wedges or flight bars that are mounted to conveyors cooperate with the guide rails to select a predetermined number of articles, arrange the articles in an article group, and transfer the article group into a container. These machines are continuous motion packaging machines intended to package articles into various types of containers without substantial flow interruption.

To properly select and group the articles, the width of the lanes is determined such that the articles in each lane are substantially aligned with one another. However, it is desired that such packaging machines have the ability to package a very wide range of article types and dimensions. Since the lane width that is used to properly package an article of a certain dimension does not necessarily work for an article of a different dimension, packaging machines with adjustable lane widths have been developed.

Previously developed adjustable lane packaging machines include parts that must be added to the lane or that are exchanged with elements of the lane to adjust the width of the lanes. For example, one packaging machine includes inserts of various widths that are secured within the lanes to adjust the width of the lanes. This system requires that an insert be developed for each article dimension to be packaged and that the inserts be changed over manually. Such a system is time, material, and cost intensive and is net infinitely adjustable. Another packaging machine includes positionable guide rails such that portions of the lane widths car be adjusted. However, the packaging machine requires that corner portions of the lanes be replaced as the lane widths are adjusted such that the upstream ends of the guide rails do not obstruct the corner portions of the lanes.

What is needed is a packaging machine that includes lanes and that is configured such that the widths of the lanes are easily adjustable. Further, it is desired that the adjustment of the widths of the lanes can be accomplished without adding, removing, or replacing elements of the packaging machine and that the adjustment can be accomplished or controlled via a programmable logic controller.

### BRIEF SUMMARY OF THE INVENTION

The various embodiments of the present invention overcome the shortcomings of the prior art by providing a packaging apparatus for conveying streams of substantially cylindrical articles in multiple adjustable lanes. The packaging machine includes a simplified apparatus and method for adjusting the width of the lanes. The improved system does net require interchangeable parts or independent adjustments. Rather, the apparatus can be operated by a simple drive system and the drive system can be controlled by a programmable logic controller.

According to an exemplary embodiment, a packaging apparatus coincident to packaging machine includes a plurality of lanes that are defined by lane dividers. Each lane includes an upstream portion and a downstream portion that are angled with respect to one another. The upstream portion is defined by first and second lane dividers that are substantially parallel to a first axis. The first and second lane dividers are spaced apart to define an upstream lane width. The downstream portion is defined by third and fourth lane dividers that are substantially parallel to a second axis. The first axis is at an angle with respect to the second axis. The third and fourth lane dividers are spaced apart to define a downstream lane width. The position of one or both of the third and fourth lane dividers is adjustable relative to the position of the other such that the downstream lane width is adjustable. Specifically, either or both of the third and fourth lane dividers can be translated in a direction parallel to the first axis to adjust the downstream lane width. To facilitate this translation, the translated lane divider may include a transition tip that maintains contact between the upstream end of the translated downstream lane divider and the downstream end of the adjacent upstream lane divider.

According to one aspect of the invention, the first axis coincides with a general direction of flow of the articles through lanes of the packaging apparatus. In other words, as the articles travel along the upstream portion and the downstream portions, the primary displacement of the articles occurs along the first axis.

As another aspect of the invention, a translating apparatus is provided to facilitate translating one of the first and second downstream lane dividers along the first axis. In certain embodiments, the translating apparatus includes a beam that is slidingly engaged with linear bearings. The translating apparatus may be operated, for example, by a drive system including an axle that is driven by a rotary motor, wherein pinions that are attached to the axle interface with racks that are attached to the translating apparatus. In certain other embodiments, other suitable means for causing translation are used alone or in combination, such as but not limited to conveyor drives systems, air actuated pistons, and the like.

According to another aspect of the invention, translation to adjust the width of the downstream portion of lane can be effected manually or automatically, in certain embodiments, therefore, an electronic or electromechanical controller is provided to automatically cause translation of the movable downstream lane dividers. The controller includes or interfaces with a processor that processes instructions stored on a computer readable medium to cause the translation apparatus to operate, in response to manually or automatically generated control signals. In certain other embodiments, manual effort applied to, for example, a lever, a hand crank or a handle attached to a linkage serves the same purpose.

The present invention provides a method for configuring the packaging apparatus from processing a run of multiple substantially uniform articles having a first diameter to a subsequent run of multiple substantially uniform articles having a second diameter that differs from the first diameter. It follows that the maximum diameter of article that can be processed is dictated by the width of the upstream portion of each lane, so the downstream portion is adjustable to a width that is no greater than the maximum width of the upstream portion. According to one aspect of the exemplary method, adjusting the width of the downstream portion of each lane involves translating the adjustable lane divider in a direction that is substantially parallel to the first axis, which as previously mentioned, lies at an angle with respect to the second axis. This translation continues until the width of the downstream portion corresponds to the diameter of the articles in the second run. More specifically, the width of the downstream portion is adjusted until it is equal to the diameter of the current run of articles plus a predetermined allowance, for example, to prevent undesirable friction end damage to the surface of each article traveling down the lane.

The foregoing has broadly outlined some of the aspects and features of the present invention, which should be construed to be merely illustrative of various potential applications of the invention. Other beneficial results can be obtained by applying the disclosed information in a different manner or by combining various aspects of the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

### BRIEF DESCRIPTION OF THE DRAWINGS

FIG. 1 is a partial perspective view of an exemplary packaging apparatus.

FIG. 2 is a partial plan view showing the adjustable lanes of the packaging apparatus of FIG. 1, according to the present invention.

FIG. 3 is a partial plan view showing one of the lanes of the packaging apparatus of FIG. 1.

FIGS. 4 and 5 are exploded perspective views of lane dividers of the packaging apparatus of FIG. 1.

FIG. 6 is an exploded perspective view of a support structure of the packaging apparatus of FIG. 1.

FIG. 7 is a partial perspective view of a sliding support system that includes the support structure of FIG. 6.

FIG. 8 is an exploded perspective view of a lane tower assembly of the packaging apparatus of FIG. 1.

FIGS. 9 and 10 are partial plan views of the bottom of a lane tower assembly of the packaging apparatus of FIG. 1.

FIG. 11 is an exploded perspective view of a drive system of the packaging apparatus of FIG. 1.

### DETAILED DESCRIPTION

As required, detailed embodiments of the present invention are disclosed herein. It must be understood that the disclosed embodiments are merely exemplary of the invention that may be embodied in various and alternative forms, and combinations thereof. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods have not been described in detail in order to avoid obscuring the present invention. Therefore, specific structural and functional details disclosed herein are not to be interpreted as limiting, but merely as a basis for the claims and as a representative basis for teaching one skilled in the art to variously employ the present invention.

Referring now to the drawings in which like numerals indicate like elements throughout the several views, the drawings illustrate certain of the various aspects of exemplary embodiments of a packaging machine for transporting, directing, guiding, aligning, arranging, or processing articles along paths and for grouping the articles before loading the groups of articles into cartons or containers. Generally described, the packaging machine includes an apparatus for adjusting the lanes to accommodate articles of different diameters.

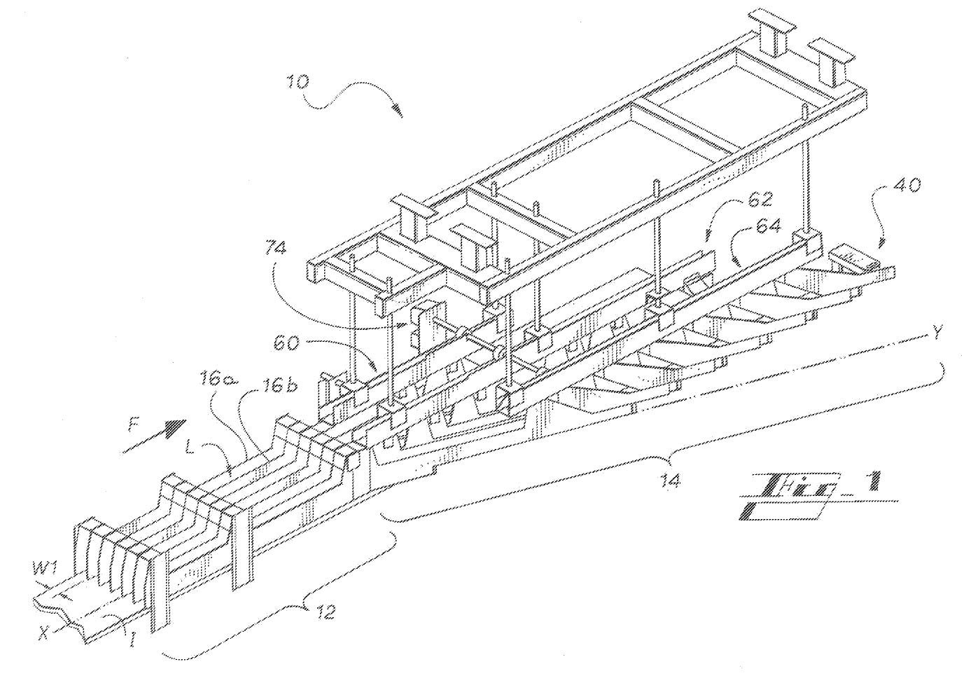

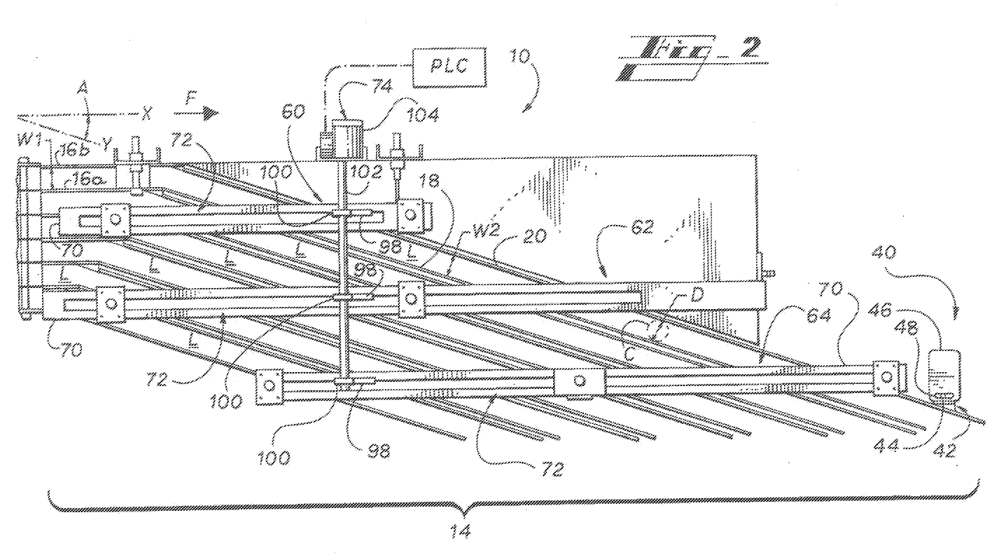

Referring to FIGS. 1 and 2, a portion of an exemplary embodiment of a packaging apparatus 10 is illustrated. The packaging apparatus 10 may be a component of or may encompass a packaging machine (not shown) that functions to convey, group, and package cylindrical articles C, such as cans or bottles. Parallel conveyors, including an infeed conveyor I and an outfeed conveyor (not shown), support the articles C and transport or convey the articles C in a flow direction F. It should be understood that only a portion of the support surface of the infeed conveyer I is illustrated in FIG. 1. The illustrated portion of the packaging apparatus 10 defines lanes L in which the articles C are guided along substantially parallel paths.

The lanes L guide the articles C generally in the flow direction F. For example, to move the articles C from one conveyor to the next, the lanes L are angled with respect to the flow direction F such that the articles G move in a direction that is substantially transverse to the flow direction F in addition to moving in the flow direction F. It should be understood that the width of each portion of each lane L is no less than the diameter D of articles C that are to be conveyed in the lane L. For example, the width of a portion of the lane L can be a function of the diameter D of articles C that are conveyed in the lane L so as to be equal to the diameter D of the articles C plus a tolerance that is predetermined to allow the articles to move smoothly through the lanes L. Further, the width of each portion of each lane L can be limited to a maximum width such that articles C having a minimum diameter D move through the lanes L in an ordered fashion.

As used herein, the terms “upstream” and “downstream” denote a relative position or a direction with respect to the flow direction F or with respect to the direction of travel of articles C along the length of a path or within a lane L.

Each lane L is defined by lane dividers or guide rails that are spaced apart and substantially parallel to one another. In the exemplary embodiment, each of the lanes includes an upstream portion 12 and a downstream portion 14 as best identified in FIG. 3. For clarity, a single lane is shown in FIG. 3 and described in further detail below. However, it should be understood that a description of one of the lanes is generally applicable to each of the other lanes. It should be noted that the packaging machine described herein can be arranged, configured, or altered to include one or more lanes.

Referring to FIGS. 1-3, the upstream portion 12 of each lane L is defined by upstream lane dividers 16a, 16b that are substantially parallel to an axis X. The upstream lane dividers 16a, 16b are spaced apart from one another to define and upstream lane width W1 that may be slightly greater than, if not generally equal to, the maximum diameter D of the articles C or may be substantially greater than the maximum diameter D. In the exemplary embodiment, the flow direction F is aligned with the axis X. However, in alternative embodiments, the flow direction F is at an angle with respect to the axis X.

The downstream portion 14 of a lane L is defined by the downstream lane dividers 18, 20 that are substantially parallel to an axis Y. The axis Y is at an angle A with respect to the axis X such that downstream portion 14 of the lane L is at an angle A with respect to the upstream portion 12 of the lane L. The downstream lane dividers 18, 20 are spaced apart from one another to define a downstream lane width W2 that may be slightly greater than, if not generally equal to, the maximum diameter D of the articles C or may be substantially greater than the maximum diameter D. In the exemplary embodiment, the position of the downstream lane divider 18 is fixed and the position of the downstream lane divider 20 is variable such that the width W2 is adjustable, as described in further detail below.

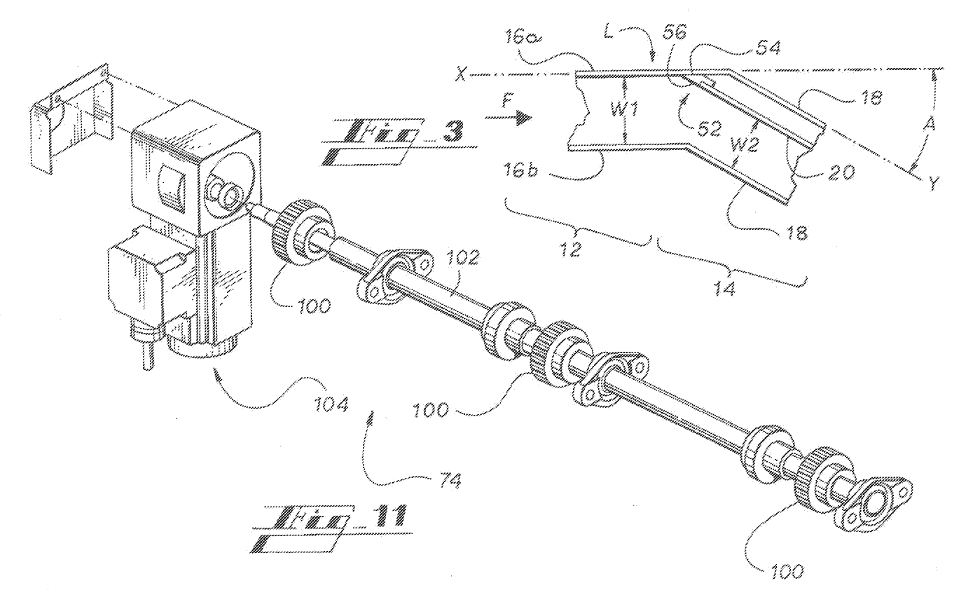

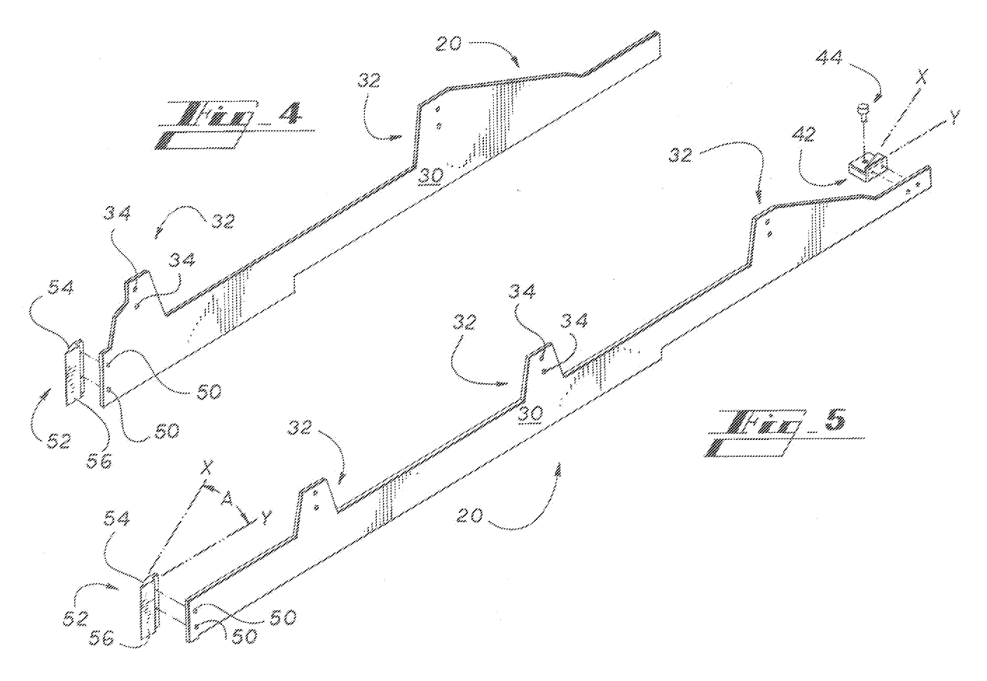

In the exemplary embodiment, the downstream portions 14 of the lanes L have different lengths. That is, each successive downstream portion 14 is longer than the previous downstream portion 14. Accordingly, the downstream lane dividers 18, 20 that define the downstream portions 14 of the lanes L have different lengths. Referring to FIGS. 4 and 5, adjustable downstream lane dividers 20 of different lengths are illustrated. Each adjustable downstream lane divider 20 is an elongated, substantially flat plate that includes a body 30 and attachment extensions 32. Each attachment extension 32 includes apertures 34 to facilitate attachment to a support or connecting block, as described in further detail below.

The adjustable downstream lane dividers 20 are supported at the attachment extensions 32. In the exemplary embodiment, the longer adjustable downstream lane divider 20 illustrated in FIG. 5 includes three attachment extensions 32 and the shorter adjustable downstream lane divider 20 illustrated in FIG. 4 includes two attachment extensions 32. The number of attachment extensions 32 for each downstream lane divider 18, 20 is merely a design decision. For certain applications, the lane dividers 18, 20 can include additional attachment extensions to provide additional support.

With the exception of the outermost adjustable lane divider 20, the adjustable lane dividers 20 are each additionally supported by an adjacent fixed lane divider 18 that defines an adjacent lane L. Specifically, adjacent downstream lane dividers 18, 20 support one another as the downstream lane dividers 18, 20 are pushed toward one another by articles C moving through adjacent lanes L.

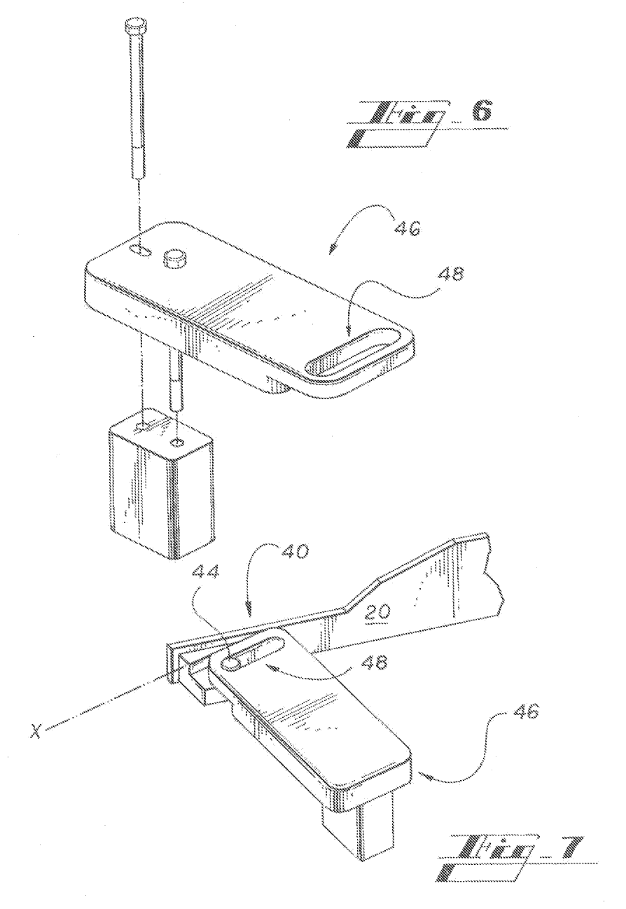

Referring to FIGS. 1, 2, and 5-7, the outermost adjustable downstream lane divider 20 illustrated in FIG. 5, which defines the longer of the outermost lanes L, is additionally supported by a sliding support system 40. The sliding support system 40 provides support to the downstream end of the longer outermost adjustable downstream lane divider 20. The sliding support system 40 includes an attachment block 42 that includes a roller 44 and a support structure 46 that includes a slot 48 that receives the roller 44. The slot 48 is aligned with or parallel to the axis X such that the roller 44 can translate back and forth along the axis X within the slot 48. Thereby, the distal downstream end of the longer outermost adjustable downstream lane divider 20 can translate along the axis X and is supported in directions that are substantially perpendicular to the axis X.

Referring to FIGS. 4 and 5, the upstream end of each adjustable downstream lane divider 20 includes apertures 50 to facilitate the attachment of a transition tip 52. Each transition tip 52 is dimensioned to attach to the upstream end of an adjustable downstream lane divider 20 and to slidingly contact an upstream lane divider 16. In the exemplary embodiment, each transition tip 52 includes a sliding contact surface 54 and an article transition surface 56 that taper towards one another at an angle A.

The fixed downstream lane dividers 18 are substantially similar to the adjustable downstream lane dividers 20 but do not include a transition tip 38 attached thereto. Rather, the fixed downstream lane dividers 18 are attached or integral to an upstream lane divider 16. Referring to FIG. 3, five upstream end of each fixed downstream lane divider 18 can bend such that the upstream end of the fixed downstream lane divider 18 aligns with the upstream lane divider 16 and is parallel to the axis X while the body of the fixed downstream lane divider 18 is parallel to the axis Y.

Referring again to FIGS. 1 and 2, the packaging apparatus 10 further includes support tower assemblies 60, 62, 64 that are each longitudinally aligned or otherwise substantially parallel to the axis X. The support tower assemblies 60, 62, 64 are positioned to support and position the downstream lane dividers 18, 20 and are suspended above the downstream portions 14 of the lanes L by a support frame. Referring to FIG. 1, the exemplary support frame includes rods and brackets that provide vertical support and beams that provide horizontal support.

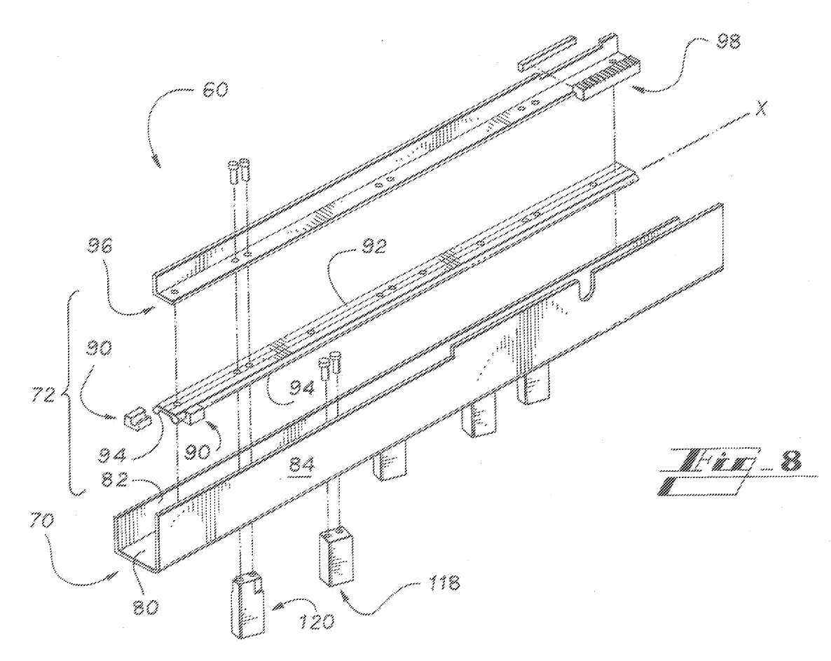

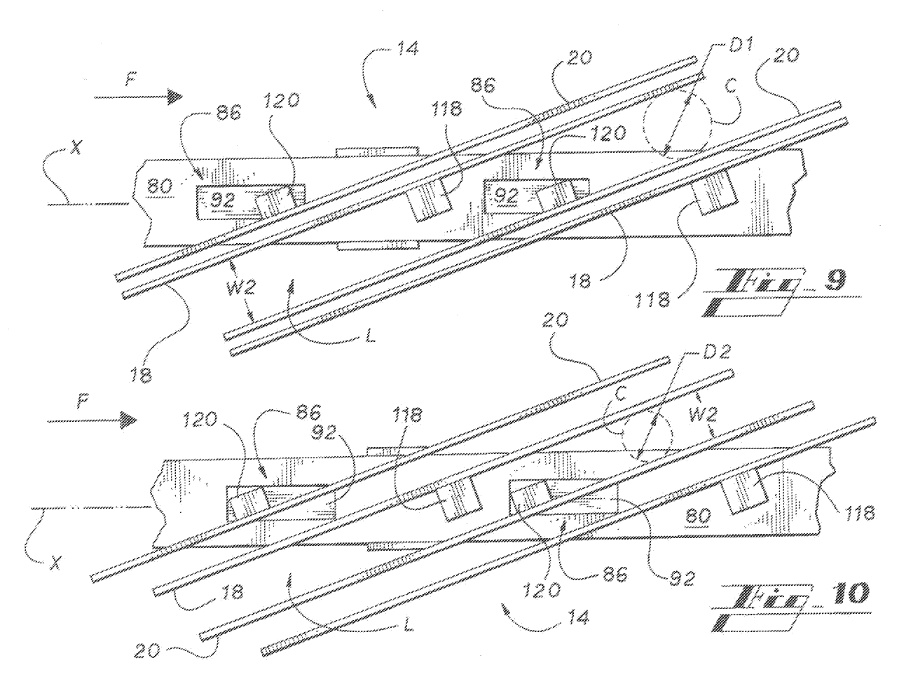

Referring to FIG. 8, each support tower assembly 60, 62, 64 includes a support beam 70 and a translating apparatus 72 that interfaces with a drive system 74. The support beams 70 are substantially U-shaped and include a bottom wall 80 and side walls 82, 84. Referring momentarily to FIGS. 9 and 10, the bottom wall 80 of each support beam 70 includes apertures or slots 86, as described in further detail below.

Referring again to FIG. 8, the exemplary translating apparatus 72 includes linear bearings 90, a sliding beam 92 including linear bearing rails 94, L-shaped beam 96, and a rack 98. The linear bearings 90 are attached to the inside surface of the bottom wall 80. The linear bearing rails 94 of the sliding beam 92 are slidably received by the linear bearings 90 such that the sliding beam 92 can translate back and forth along the axis X with respect to the support beam 70. The L-shaped beam 96 is attached to the sliding beam 92 such that a portion of the L-shaped beam 96 extends substantially vertically. The rack 98 is attached to the vertically extending portion of the L-shaped beam 96. The L-shaped beam 98 functions to position the rack 98 to be engaged by the drive system 74, as described in further detail below.

Referring to FIG. 11, the drive system 74 includes gears or pinions 100, an axle 102, and a rotary motor 104. The pinions 100 are attached to the axle 102, which is driven by the rotary motor 104. Referring to FIGS. 1 and 2, the drive system 74 is positioned above and extends across each of the support tower assemblies 60, 62, 64 such that the pinions 100 interface with or engage the racks 98 of the translating apparatuses 72, respectively. Specifically, the teeth of the pinion 100 intermesh with the teeth of the rack 98. The rotation of the pinions 100 about a fixed axis, the axis being defined by the axle 102, thereby translates the sliding beams 92.

Referring to FIGS. 8-10, the fixed downstream lane dividers 18 and the adjustable downstream lane dividers 20 are each attached to one or more of the support tower assemblies 60, 62, 64 by support blocks 118, 120. The support blocks 118, 120 are attached to the attachment extensions 32 of the downstream lane dividers 18, 20. Fixed support blocks 110 are additionally attached to the bottom walls 80 of the support beams 70 so as to extend downwardly from the outer surfaces of the bottom walls 80. Adjustable support blocks 120 are additionally attached to the sliding beams 92 so as to extend downwardly through the slots 86 in the bottom walls 80.

As the attachment extensions 32 of each fixed downstream lane divider 18 are attached to fixed support blocks 118, each fixed downstream lane divider 18 is thereby positioned in place to provide a first wail of a downstream portion 14 of a lane L. The upstream end of each fixed downstream lane divider 18 is further attached or adjacent to the downstream end of a respective upstream lane divider 16 to provide a substantially continuous first wall of each lane L that extends from the upstream portion 12 to the downstream portion 14.

As the attachment extensions 32 of each adjustable downstream lane divider 20 are attached to adjustable support block 120, each adjustable downstream lane divider 20 is thereby positioned in place to provide a second wail of a downstream portion 14 of a lane L. Referring to FIG. 3, the sliding contact surface 54 of each transition tip 52, which is attached at the upstream end of each adjustable downstream lane divider 20, slidably contacts an upstream lane divider 16 to provide a substantially continuous second wall of each lane L that extends from the upstream portion 12 to the downstream portion 14. The transition surface 56 of the transition tip 38 provides a smooth transition between each upstream lane divider 16 and a respective adjustable downstream lane divider 20 such that the upstream end of the adjustable downstream lane divider 20 does not obstruct articles C as they move in the lane L. In alternative embodiments, the transition tip 38 can be integral to the adjustable downstream lane divider 20 or can be omitted.

Referring to FIGS. 2, 9, and 10, since the adjustable downstream lane dividers 20 are connected to the translating apparatuses 72, the adjustable downstream lane dividers 20 can thereby translate in directions along or parallel to the axis X to adjust the downstream lane width W2 of each lane L. To narrow the downstream portions 14 of the lanes L, the adjustable downstream lane dividers 20 are moved in the upstream direction. To widen the downstream portions 14 of the lanes L, the adjustable downstream lane dividers 20 are moved in the downstream direction. As the adjustable downstream lane dividers 20 translate along the axis X, the sliding contact surfaces 54 of the transition tips 52 remain in sliding contact with the upstream lane dividers 16. Thereby, the transition tips 52 continue to provide a transition surface 56 between the upstream and downstream lane dividers 16, 20 as the adjustable downstream lane dividers 20 move.

In the exemplary embodiment, the drive system 74 and support tower assemblies 60, 62, 64 are arranged such that operating the drive system 74 moves each of the adjustable downstream lane dividers 20 simultaneously. In alternative embodiments, the adjustable downstream lane dividers 20 can be moved individually and/or manually.

Operating the packaging apparatus 10 includes adjusting the downstream width W2 of the lanes L according to the diameter D or other dimension of the articles C that are to be conveyed through the lanes L. In this manner, the packaging apparatus 10 can accommodate articles C with differing dimensions such as a first diameter D1 and a second diameter D2. The adjusting method or operation may be manually performed. Alternatively, the adjusting method can be performed according to one or more user-created logic programs that are stored on a computer readable medium and executed by a programmable logic controller (PLC). The PLC may be programmed directly, or the logic programs may be downloaded or relayed from a computer (not shown). The PLC has either modular or integral input/output circuitry that monitors the status of field connected sensor inputs, including sensors, and controls attached to output actuators, including devices such as motor starters, solenoids, pilot lights/displays, drives, vacuum valves, and the like (not shown) according to the programs stored in the random-access (RAM) portion of memory. A system bus couples memory, sensor inputs, and output actuators to the PLC. If the PLC receives programming from a computer, the computer typically further includes additional computer-readable media, such as low speed storage, such as a hard disk drive or a magnetic disk drive, and the like, to read from or write to a removable disk, and an optical disk drive for reading a CD-ROM disk or to read from or write to other optical media. The hard disk drive, magnetic disk drive, and optical disk drive include a hard disk drive interface, a magnetic disk drive interface, and an optical drive interface, respectively (not shown), for coupling the drives to the system bus. The drives and their associated computer-readable media provide nonvolatile storage for the computer. Although the description of computer-readable medium above refers to a hard disk, a portable USB drive, a removable magnetic disk, a CD-ROM disk, other types or media readable by a computer, such as magnetic cassettes, flash memory cards, digital video disks, Bernoulli cartridges, and the like, can also be used.

A number of program modules can be stored in the drives and in the RAM portion of memory, including an operating system, one or more application programs, a shared code library, and a browser program module. A user may enter commands and information info the computer through a human/machine interface (HMI), such as but not limited to a keyboard and pointing device, such as a mouse. The HMI may incorporate other input/output devices such as a microphone, joystick, scanner, pushbuttons, LEDs, and the like. These and other input/output devices may be connected to the PLC or the processing unit of the computer through a serial port interface coupled to the system bus, but can be connected by other interfaces, such as a universal serial bus (USB) (not shown). The input/output devices include a monitor or other type of display device connected to the system bus via an interface, such as a video adapter. In addition to the monitor, computers typically include other peripheral output devices, such as speakers or printers.

According to an exemplary method, a diameter D can be entered or selected through the HMI as input for a logic program. The PLC accordingly executes the logic program and sends the output to the rotary motor 104. The motor 104 rotates the axle 102 to simultaneously translate each of the adjustable downstream lane dividers 20 in the proper direction, and by the proper amount, such that the desired lane width W2 of each lane L is achieved for the input diameter D.

It should be understood the translating apparatus 72 and the drive system 74 are not limited to the elements and configurations of elements described herein. In alternative embodiments, the translating apparatus can include alternative means for translating including, but not limited to, wheel and track arrangements, rollers, various types of bearings, conveyor-type systems, a screw mechanism that attaches to a threaded bearing, combinations thereof, and the like.

Further, in alternative embodiments the system for driving the translating apparatus can include alternative means for driving including, but not limited to, conveyor drive systems, air actuated pistons, a hand crank that drives a shaft or axle, manual or hand forces, a handle attached to a linkage, combinations thereof, and the like.

It should be understood that, in alternative embodiments, the exemplary fixed lane dividers can be adjustable and the exemplary adjustable lane dividers can be fixed such that the downstream lane dividers move relative to one another to adjust the width of the downstream portions of the lanes.

The above-described embodiments are merely exemplary illustrations of implementations set forth for a clear understanding of the principles of the invention. Variations, modifications, and combinations may be made to the above-described embodiments without departing from the scope of the claims. All such variations, modifications, and combinations are included herein by the scope of this disclosure and the following claims.

1. A packaging apparatus, comprising:
an infeed conveyor defining a first axis; and
a plurality of lanes each for guiding a stream of articles conveyed by said infeed conveyor, each lane comprising a downstream portion defining a second axis, said downstream portion being defined by a first downstream lane divider spaced apart from and substantially parallel to a second downstream lane divider;
wherein said first axis is at an angle with respect to sale second axis; and
wherein a width of the downstream portion is adjustable by translating one of said first downstream and said second downstream lane dividers along said first axis.

2. The packaging apparatus of claim 1, each lane further comprising an upstream portion defined by a first upstream lane divider spaced apart from and substantially parallel to a second upstream lane divider, wherein said upstream portion is substantially parallel to said first axis.

3. The packaging apparatus of claim 1, wherein said first axis defines a general direction of flow of said articles through said packaging apparatus.

4. The packaging apparatus of claim 1, further comprising a translating apparatus that facilitates translating said one of said first downstream and said second downstream lane dividers along said first axis.

5. The packaging apparatus of claim 4, the translating apparatus comprising a beam that is slidingly engaged with linear bearings.

6. The packaging apparatus of claim 4, wherein the translating apparatus is translated by a drive system.

7. The packaging apparatus of claim 6, wherein the drive system includes an axle that is driven by a rotary motor, wherein pinions are attached to the axle and interface with racks that are attached to the translating apparatus.

8. The packaging apparatus of claim 1, wherein one of said first downstream and said second downstream lane dividers are fixed.

9. The packaging apparatus of claim 1, wherein said one of said first downstream and said second downstream lane dividers that is translated along said first axis includes a transition tip that is disposed at the upstream end of said downstream lane divider.

10. The packaging apparatus of claim 1, further comprising a controller for automatically causing translation of one of said first downstream and said second downstream lane dividers.

11. A method for configuring a packaging apparatus from processing a plurality of articles having a first diameter to a plurality of articles having a second diameter, said packaging apparatus comprising a plurality of lanes each for guiding a stream of articles conveyed by an infeed conveyor defining a first axis, said method comprising adjusting the width of a downstream portion of at least one of said lanes, said downstream portion of said at least one of said lanes defining a second axis, said downstream portion of said at least one lane being defined by a fixed lane divider and an adjustable lane divider that is substantially parallel to and spaced apart from said fixed lane divider;
wherein adjusting the width of said downstream portion comprises translating said adjustable lane divider in a direction substantially parallel to said first axis, said first axis being at an angle with said second axis until said width corresponds to said second diameter.

12. A computer-readable medium comprising computer-executable instructions which, when executed, cause a translating apparatus to perform the method of claim 11.
